(19) United States
(12) Patent Application Publication
(10) Pub. No.: US 2015/0188893 A1
(43) Pub. Date: Jul. 2, 2015

(54) Secure Gateway

(71) Applicant: Arun Sood, Clifton, VA (US)

(72) Inventor: Arun Sood, Clifton, VA (US)

(21) Appl. No.: 14/143,208

(22) Filed: Dec. 30, 2013

(51) Int. Cl. H04L 29/06

(52) U.S. Cl. CPC H04L 63/0435

(57) ABSTRACT

A secure gateway includes data storage for outgoing data and encrypted incoming data. SCIT server(s) rotate through unexposed mode(s) and exposed mode(s). If there is outgoing data in the data storage: the unexposed mode(s) retrieve outgoing data from the data storage; retrieve an encryption key from a key server; generate encrypted outgoing data by encrypting the outgoing data with the encryption key; delete the encryption key; and delete the outgoing data from the data storage. If there is encrypted incoming data in the data storage, the unexposed mode(s): retrieve encrypted incoming data from the data storage; retrieve a decryption key from the key server; generate incoming data by decrypting the encrypted incoming data with the decryption key; delete the decryption key; and delete the encrypted incoming data. The exposed mode: receives encrypted incoming data over an exposed interface; and transmits encrypted outgoing data over an exposed interface.

### BRIEF DESCRIPTION OF THE SEVERAL VIEWS OF THE DRAWINGS

FIG. 1 is an example block diagram of an internal network connected to an external application on an external network.

FIG. 2 is an example block diagram of an internal network connected to an external application on an external network through an encryption gateway.

FIG. 3 is an example block diagram of an internal network connected to an external cloud application through a secure gateway as per an aspect of an embodiment of the present invention.

FIG. 4 is an example block diagram of an internal network connected to an external cloud application through a secure gateway as per an aspect of an embodiment of the present invention.

FIGS. 5-9 are example block diagrams of various secure gateways as per various aspects of embodiments of the present invention.

FIG. 10 is an example diagram illustrating example Self-Cleansing Intrusion Tolerant (SCIT) server rotations as per various aspects of embodiments of the present invention.

FIG. 11 is an example flow diagram of a secure gateway operation(s) as per aspects of an embodiment of the present invention.

FIG. 12 is a block diagram of a computing environment in which aspects of embodiments of the present invention may be practiced.

### DETAILED DESCRIPTION OF EMBODIMENTS

Embodiments of the present invention provide a secure gateway that protects internal network(s) from exploitation via external network interfaces(s) by encrypting data in system that is regularly reset to a known good state to prevent intruders from being resident in the gateway for more than a few minutes.

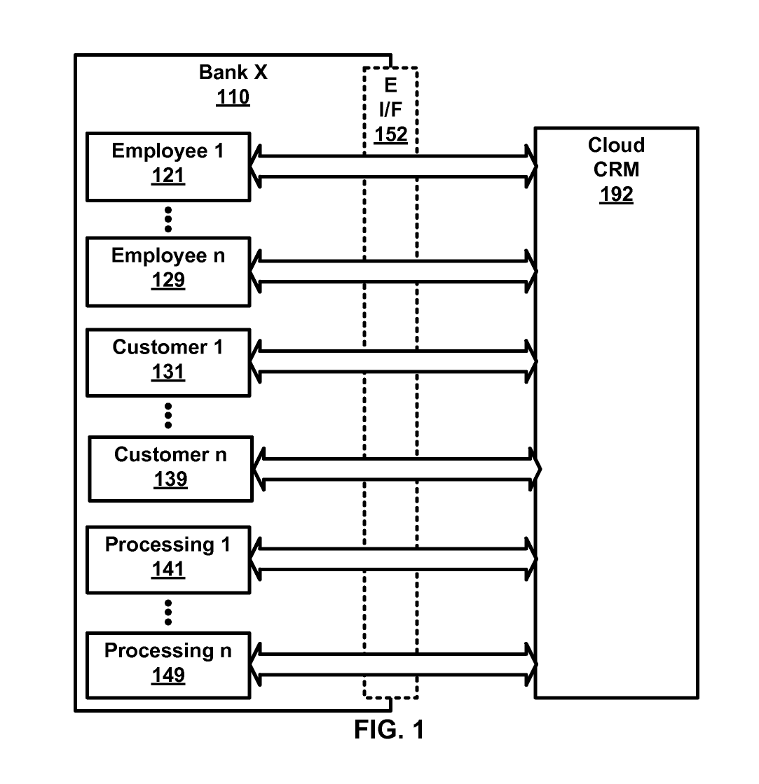

Businesses interact and utilize services provided by external entities. For example, as illustrated in FIG. 1, a bank 110 may use a cloud based CRM system 192 (such as SalesForce [dot] com of San Francisco, Calif.). Businesses may make such choices because of the quality and efficiency of the service provided. Since the scale of implementation of the service may be much larger than any one business, the overall cost of the service may be lower. Also, using a cloud based service may mean fewer bank personnel, training and operations cost. FIG. 1 show one approach that is available for the Bank 210 employees (121 . . . 129), customers (131 . . . 139), processing applications (141 . . . 149), and/or the like to access data stored in the cloud. Typically, as illustrated in this example, the cloud application 192 is accessed through the internet using an https link through an exposed interface 152.

However, this solution may not be considered adequate by corporate risk managers. Often bank risk management teams require that all data bases containing customer specific data to be encrypted. In this way, even if the data is stolen, the customer data is protected. The law and accounting offices may have a similar need to protect the cyber assets and the intellectual property of the firm and the customer. Many of the cloud services do not provide a service to encrypt and decrypt the data flow.

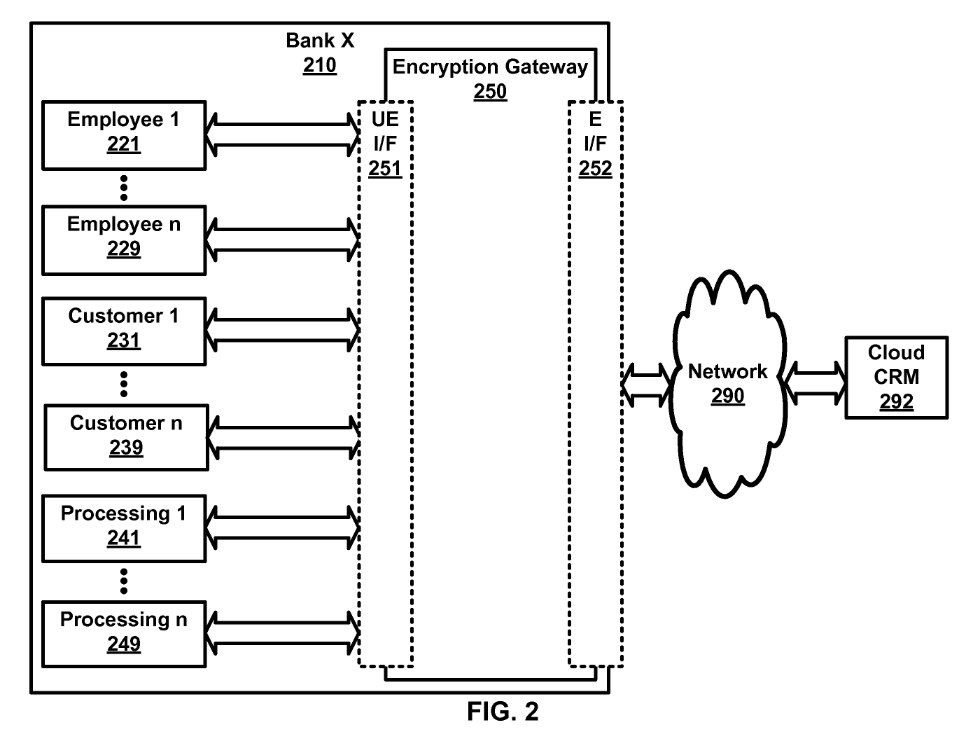

An encryption gateway may be one way to meet the encryption of data at rest requirement of Payment Card Industry Data Security Standard (PCI DSS) and of risk managers. FIG. 2 is an example block diagram of an internal network connected to an external cloud application 292 over an external network 290 through an encryption gateway 250. The internal network of the illustrative bank 210 may allow Bank 210 employees (121 . . . 129), customers (131 . . . 139), processing applications (141 . . . 149), and/or the like to connect to the encryption gateway 250 via an internal unexposed interface 251. Encryption gateway 250 may act as a data collector, undertaking some pre-processing steps of importance to Bank 210 and encrypting data from the internal network. This encrypted data may be forwarded to the Cloud CRM 292 through an exposed interface 252 and external network 290. On the other hand, when data is to be retrieved from the CRM 292, the data may be decrypted at the Encryption Gateway 250 and forwarded to the distributed network of the bank sales team (121 . . . 129), customers (131 . . . 139), processing applications (141 . . . 149), and/or the like. In this approach, the applications used by Bank 210 may not need to be changed. The Encryption Gateway 250 is one of the nodes on the Bank 210 network, and the existing access mechanisms may be used by the employees (121 . . . 129), customers (131 . . . 139), processing applications (141 . . . 149), and/or the like to access the data.

An enterprise gateway may need to meet Payment Card Industry Data Security Standard (PCI DSS) requirements. For example, PCI DSS recommends encryption of data at rest and a host intrusion detection system (IDS). The Encryption Gateway 250 may meet the requirement of encrypting the data at rest without additional investment in applications. However, a key challenge remains. What if a malicious adversary inserts malware in the Encryption Gateway 250? This adversary may have access to the raw unencrypted data. How easy is it for Bank 210 to detect such an intruder? Experience shows, that not only the intruders are able to bypass the prevention, detection and other protection layers, but they may remain in the system undetected for long periods of time—days, weeks and months.

Various embodiments of the present invention employ a Self-Cleansing Intrusion Tolerant (SCIT)ized Secure Gateway that has the advantages of the Encryption Gateway and also prevents intruders from being resident in the Gateway for more than a few minutes. This approach meets the PCI DSS encryption of data at rest requirement, and is a compensating control that replaces a host IDS thereby reducing the cost of false positive processing.

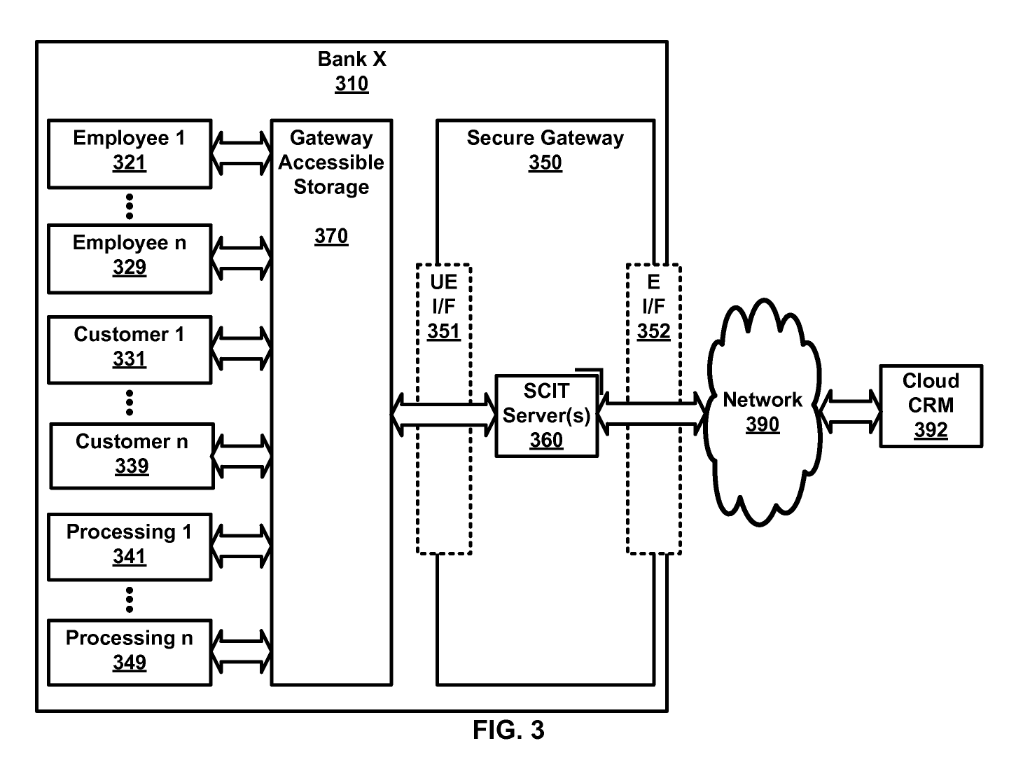

FIG. 3 is an example block diagram of an internal network connected to an external cloud application 392 through a secure gateway 350 as per an aspect of an embodiment of the present invention. Servers degrade with time. This degradation may result from memory leaks, delayed patch application or malicious activity by an adversary. Self-Cleansing Intrusion Tolerant (SCIT) server(s) 360 regularly restore server(s) to a pristine state. Thus even undetected intruders may be deleted from the SCIT server(s) 360. Regular restoration of the server(s) 360 to a pristine (predetermined) state may be performed after a selected exposure time. The exposure time may be based on time (e.g. every x seconds), or processing based (e.g. every X data processing cycle(s)). Smaller exposure times minimize access time for bad guys to do damage to the system. For example, for a high level of protection, a server may be restored approximately every minute. For less critical servers, restoration times between 10 and 30 minutes may be adequate. To avoid memory leaks or to protect against system patches, an exposure time of 1 to 4 hours may be acceptable. The basic concepts of various SCIT systems are disclosed in U.S. Pat. No. 8,260,963 to Huang et al., U.S. Pat. No. 7,725,531 to Sood et al., U.S. Pat. No. 8,356,106 to Sood, and U.S. Pat. No. 8,429,219 to Arsenault et al.

As illustrated in example FIG. 3, a bank 310 has an infrastructure that includes employees (321 . . . 329), customers (331 . . . 339), processing applications (341 . . . 349), and/or the like operating in an internal network. In this example, the employees (321 . . . 329), customers (331 . . . 339), processing applications (341 . . . 349), and/or the like may communicate with applications (such as cloud CRM 392) through an external network 390 via a secure gateway 350 and gateway accessible storage 370. Data to/from the employees (321 . . . 329), customers (331 . . . 339), processing applications (341 . . . 349), and/or the like are transported through gateway accessible storage 370. The secure gateway 350 employs SCIT server(s) 360. Gateway accessible storage 370 may act as a buffer to hold the data until the SCIT server(s) 360 are in a mode to interact with the data. The data may be transported between the gateway accessible storage 370 and the SCIT server(s) 360 via unexposed interface 351. Data may be communicated between the SCIT server(s) 360 and the external network 390 via exposed interface 352.

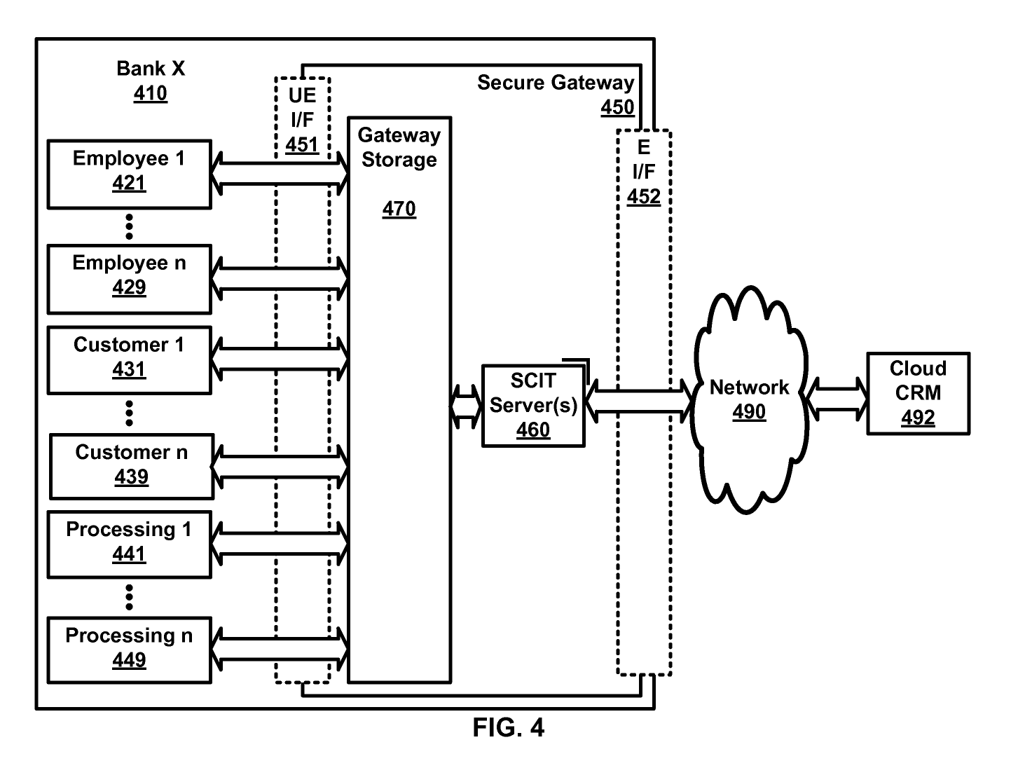

FIG. 3 illustrates an example embodiment where gateway storage 370 is external to the secure gateway 350. However, one skilled in the art will recognize that other configurations are possible. For example, FIG. 4 is an example block diagram of an internal network connected to an external cloud application 492 through an external network 490 and secure gateway 450 as per an aspect of an embodiment of the present invention where gateway storage 470 is located internal to the secure gateway 450. In this embodiment, employees (421 . . . 429), customers (431 . . . 439), processing applications (441 . . . 449), and/or the like of bank 410 operating in an internal network may communicate through unexposed interface 451 to reach gateway storage 470. Gateway accessible storage 470 may act as a buffer to hold the data until the SCIT server(s) 460 are in a mode to interact with the data. The data may be transported between the gateway accessible storage 470 and the SCIT server(s) 460 via internal secure gateway 450 communication channels. Data may be communicated between the SCIT server(s) 460 and the external network 490 via exposed interface 352.

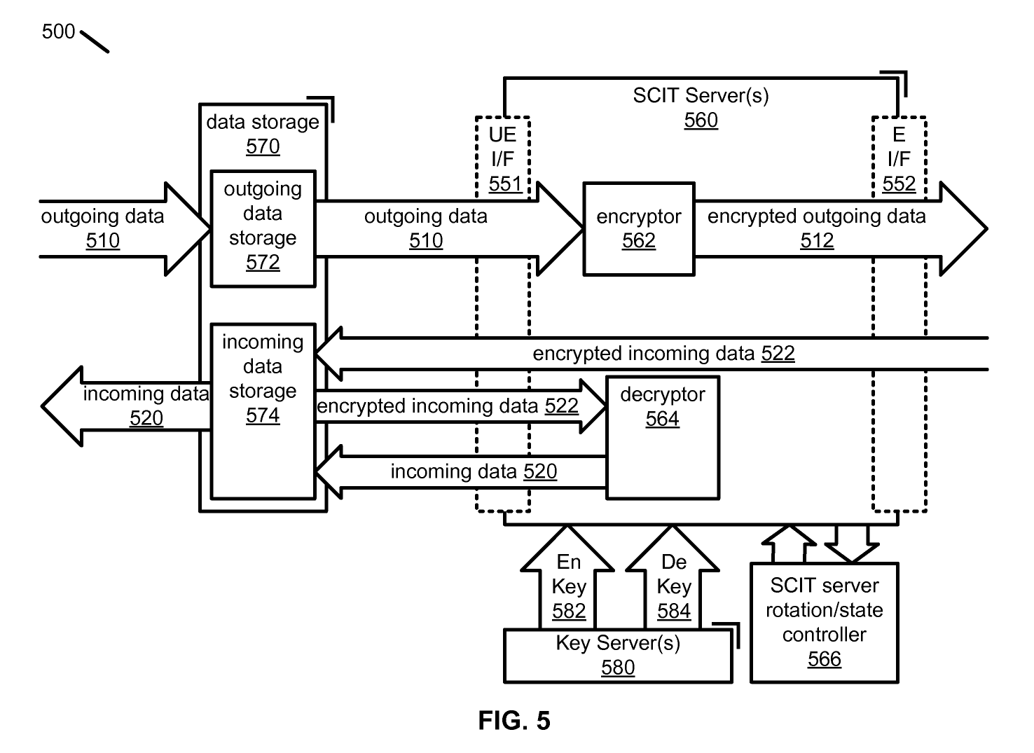

FIGS. 5-9 are example block diagrams of various secure gateways as per various aspects of embodiments of the present invention. FIG. 5 illustrates an embodiment of a secure gateway 500 comprising data storage 570 external to SCIT server(s) 560.

Data storage 570 may be configured to hold: outgoing data 510 and/or encrypted incoming data 522. Data storage 570 may have multiple storage locations, For example, outgoing data 510 may be stored in outgoing data location 572 and the encrypted incoming data 522 may be stored in incoming data location 574. Data storage 570 may be persistent storage configured to hold data while SCIT server(s) 560 rotate through various exposed and unexposed modes.

The SCIT server(s) 560 may be configured to rotate through various unexposed modes and exposed modes. The unexposed modes may be configured to periodically restore the SCIT server(s) 560 to a known state(s). This may have the effect of purging any modifications from the SCIT server 560 systems. In some of the various embodiments with multiple servers, the SCIT server(s) 560 may rotate through modes in a sequence such that while one of the SCIT server(s) 560 is in an exposed mode, other SCIT server(s) 560 are in unexposed modes. The rotations may be ad-hoc or under a central control. For example, SCTIT server controller 566 may control the rotation of the SCIT server(s) 560.

According to some of the various embodiments, the SCIT server(s) 560 may be hardware server(s). In other embodiments, the SCIT server(s) 560 may be virtual servers running on specialized computing machines with interfaces to external networks. In some embodiments, virtual machines may be configured such that more than one instance of a SCIT server 560 is hosted on a single physical server. In yet other embodiments, combinations of hardware and virtual in combination with hardware servers may be combined.

As illustrated in the example of FIG. 5, during unexposed mode(s), the SCIT server may process data being transported between internal and external networks. If there is outgoing data 510 in the data storage 572, a SCIT server 560 may retrieve the outgoing data 510 from the data storage 572, retrieve an encryption key 582 from a key server 580; generate encrypted outgoing data 512 by encrypting the outgoing data 510 with the encryption key 582; delete the encryption key 582; and delete the outgoing data 510 from the data storage 572. Similarly, if there is encrypted incoming data 522 in incoming data storage 574, a SCIT server 560 may: retrieve encrypted incoming data 522 from the incoming data storage 574; retrieve a decryption key 584 from key server 580; generate incoming data 520 by decrypting the encrypted incoming data 522 with the decryption key 584; delete the decryption key 584; and delete the encrypted incoming data 522. The incoming data 520 may be stored in the incoming data storage 574.

Encryptor 562 may use encryption to encoding messages (or information) in such a way that third parties cannot read it, but only authorized parties can. Encryption may not prevent hacking but may prevent a hacker from reading the data that is encrypted. In an encryption scheme, messages or information such as outgoing data 510 (often referred to as plain text) may be encrypted using an encryption algorithm, turning the outgoing data 510 into an unreadable cipher-text (such as encrypted outgoing data 512). This may be done with the use of an encryption key 582 which specifies how the outgoing data 510 is to be encoded. Adversar(ies) may see the cipher-text, but should not be able to determine anything about the original message. An authorized party, however, should be able to decode the cipher-text using a decryption algorithm, which usually requires a secret decryption key. Examples of encryption/decryption algorithms include the Data Encryption Standard (DES), the Advanced Encryption Standard (AES), the Digital Signature Algorithm (DSA), and the Secure Hash Algorithm (SHA).

Similarly, decryptor 564 may use decryption to decode encrypted messages (or information such as encrypted incoming data 522). This decryption may be done with the use of decryption key 584 which specifies how the encrypted incoming data 522 may be decoded.

Cryptographic systems may use different types of keys, with some systems using more than one key. Keys may include symmetric keys or asymmetric keys. In a symmetric key algorithm, the keys involved are identical for both encrypting and decrypting a message. According to some of the embodiments, the encryption key 582 and decryption key 584 may be the same symmetric key. Asymmetric keys, in contrast, are two distinct keys that are mathematically linked. They are typically used in conjunction to communicate. According to yet other embodiments, the encryption key 582 and decryption key 584 may be separate asymmetric keys.

Keys may need to be chosen carefully, and distributed and stored securely. However distributed, keys may need to be stored securely to maintain communications security. There are various techniques that may be applied to distribute and manage keys. According to some of the various embodiments, a key server 580 may be employed to manage keys. The key server 580 may employ public key infrastructure (PKI) which may use hierarchical digital certificates to provide authentication, and public keys to provide encryption. PKIs are used in World Wide Web traffic, commonly in the form of Secure Socket Layer (SSL) and Transport Layer Security (TLS). According to other embodiments, the key server 580 may employ Enterprise Key and Certificate Management (EKCM) which may include keeping an inventory of certificates, their locations and responsible parties. In yet other embodiments, the key server 580 may employ group key management techniques where keys are managed using group communications.

As illustrated in the example of FIG. 5, during exposed mode(s), the SCIT server(s) 560 may participate in the transportation of data between internal and external networks. For example, in some embodiments the SCIT server(s) 560 may receive encrypted incoming data 522 over exposed interface 552, and/or transmit encrypted outgoing data 512 over exposed interface 552. According to some of the various embodiments, the SCIT server(s) 560 may receive outgoing data 510 over the unexposed interface 551, and/or transmit incoming data 520 over the unexposed interface 551. As illustrated in FIG. 5, the encrypted incoming data 522 may be received via exposed interface 552 and stored via unexposed interface 551 in incoming data storage 574.

In some embodiments, the unexposed interface 551 may be employed to communicate with computing system(s) running application program(s). Some of the application programs may be autonomous in nature. Some application programs may provide an interface for customers, employees, and/or the like inside an unexposed network to communicate to an exposed network.

The data storage 570 may be a virtual storage location on a virtual machine or it may be all or part of a storage device. Examples of storage devices include memory, disk drives, network storage, and/or the like. Data storage may be configured to be persistent through some of the SCIT server 560 modes so that data collected in one mode may be accessible by another mode. The data storage 570 may also be configured in some embodiments to hold: encrypted outgoing data 512, and/or incoming data 520.

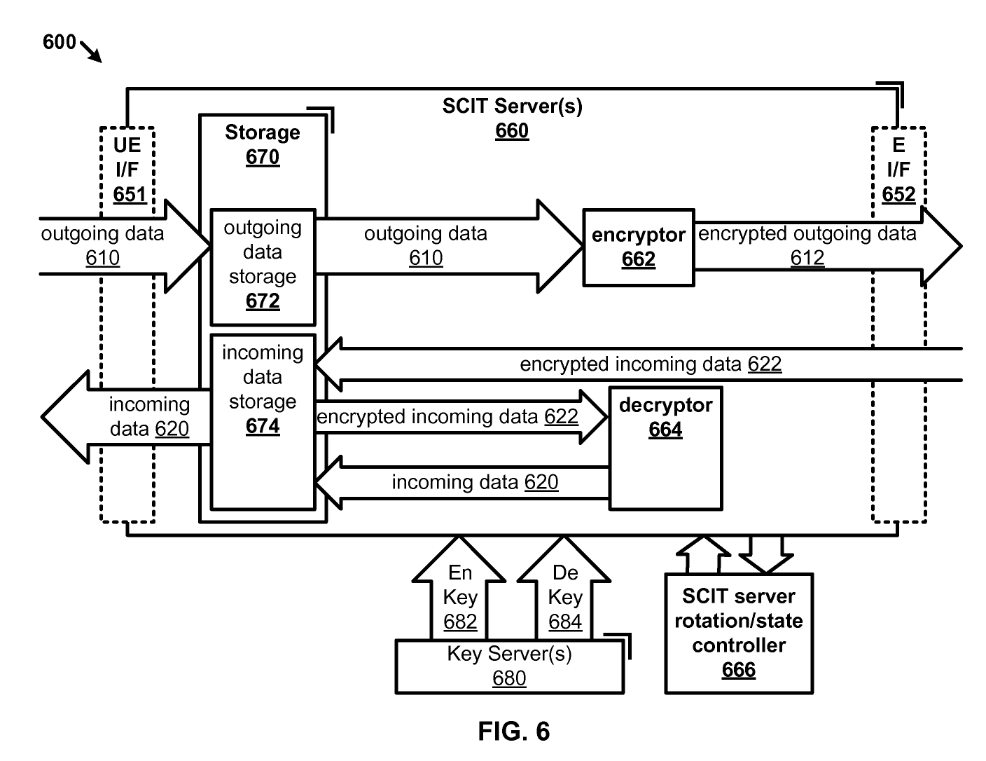

FIG. 6 illustrates an embodiment of a secure gateway 600 comprising data storage 670 that is internal to SCIT server(s) 660. In this illustrative embodiment, outgoing data 610 from an internal network may be received by the SCIT server(s) 660 through unexposed interface 651 and stored in outgoing data storage 672 during an unexposed mode. In this illustration outgoing data storage 672 may be part of storage 670. However, one skilled in the art will recognize that the outgoing data storage 672 may be separate from storage 670 in alternative embodiments. The outgoing data 610 may be encrypted by encryptor 662 employing an encryption key 682 obtained from key server(s) 680. During an exposed mode, the SCIT server(s) 660 may transport the encrypted outgoing data 612 to an external network via exposed interface 652. Encrypted incoming data 622 may be received by SCIT server(s) 660 via exposed interface 651 during an exposed mode. Encrypted incoming data 622 may be stored in incoming data storage 674. Decryptor 664 may generate incoming data 620 by decrypting the encrypted incoming data 622 employing a decryption key 684 obtained from key server(s) 680. The incoming data 620 may be stored in incoming data storage 674. One skilled in the art will recognize that the incoming data storage 674 may be separate from storage 670 in alternative embodiments. During an unexposed mode, incoming data 674 may be transported by the SCIT server(s) 660 through unexposed interface 651 to the internal network. The mode of the SCIT server(s) 660 may be controlled via a SCIT server rotation/mode controller 666. Although the SCIT server rotation/mode controller 666 is illustrated external to the SCIT server(s) 660, according to some of the various embodiments, the SCIT server rotation/mode controller 666 functionality may be performed internal and/or in between the SCIT server(s) 660.

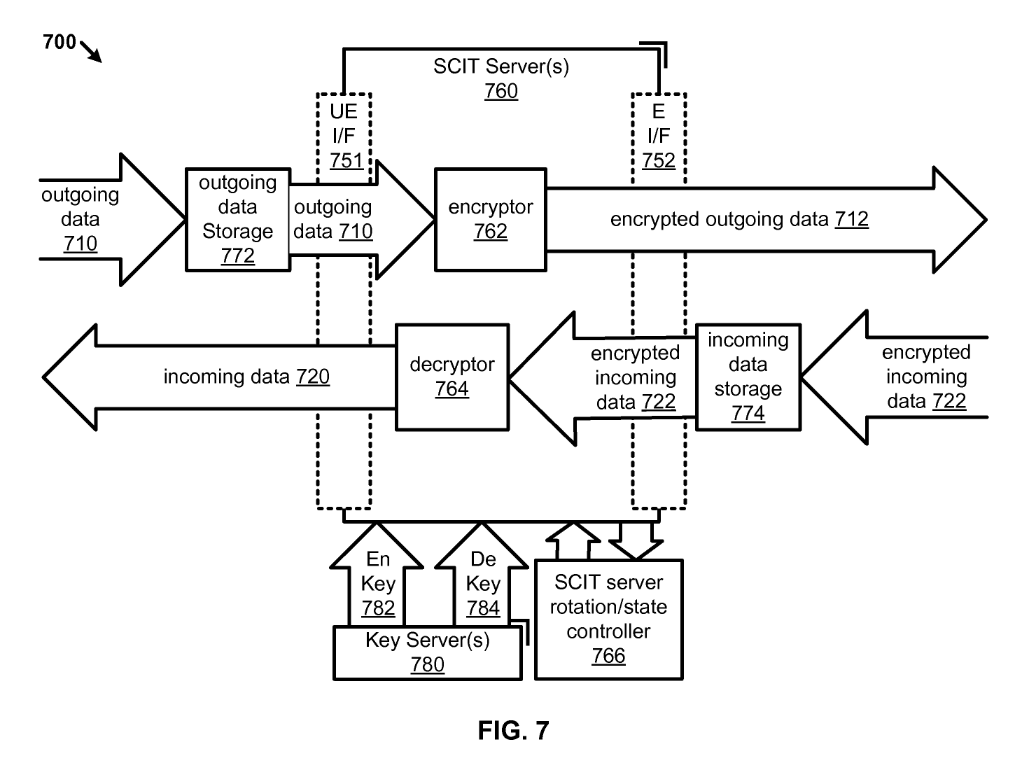

FIG. 7 illustrates an embodiment of a secure gateway 700 comprising separate outgoing data storage 772 and incoming data storage 774 located external to SCIT server(s) 760. In this illustrative embodiment, outgoing data 710 from an internal network may be stored in outgoing data storage 772. The outgoing data 710 may then be received by the SCIT server(s) 760 through unexposed interface 751 during an unexposed mode. The outgoing data 710 may be encrypted by encryptor 762 employing an encryption key 782 obtained from key server(s) 780. During an exposed mode, the SCIT server(s) 760 may transport the encrypted outgoing data 712 to an external network via exposed interface 752. Encrypted incoming data 722 may be stored in incoming data storage 774. The encrypted incoming data 722 from the incoming data storage 774 may be received by SCIT server(s) 760 via exposed interface 752 during an exposed mode. Decryptor 764 may generate incoming data 720 by decrypting the encrypted incoming data 722 employing a decryption key 784 obtained from key server(s) 780. Incoming data 720 may be transported by the SCIT server(s) 760 through unexposed interface 751 to the internal network. The mode of the SCIT server(s) 760 may be controlled via a SCIT server rotation/mode controller 766. Although the SCIT server rotation/mode controller 766 is illustrated external to the SCIT server(s) 760, according to some of the various embodiments, the SCIT server rotation/mode controller 766 functionality may be performed internal and/or in between the SCIT server(s) 760.

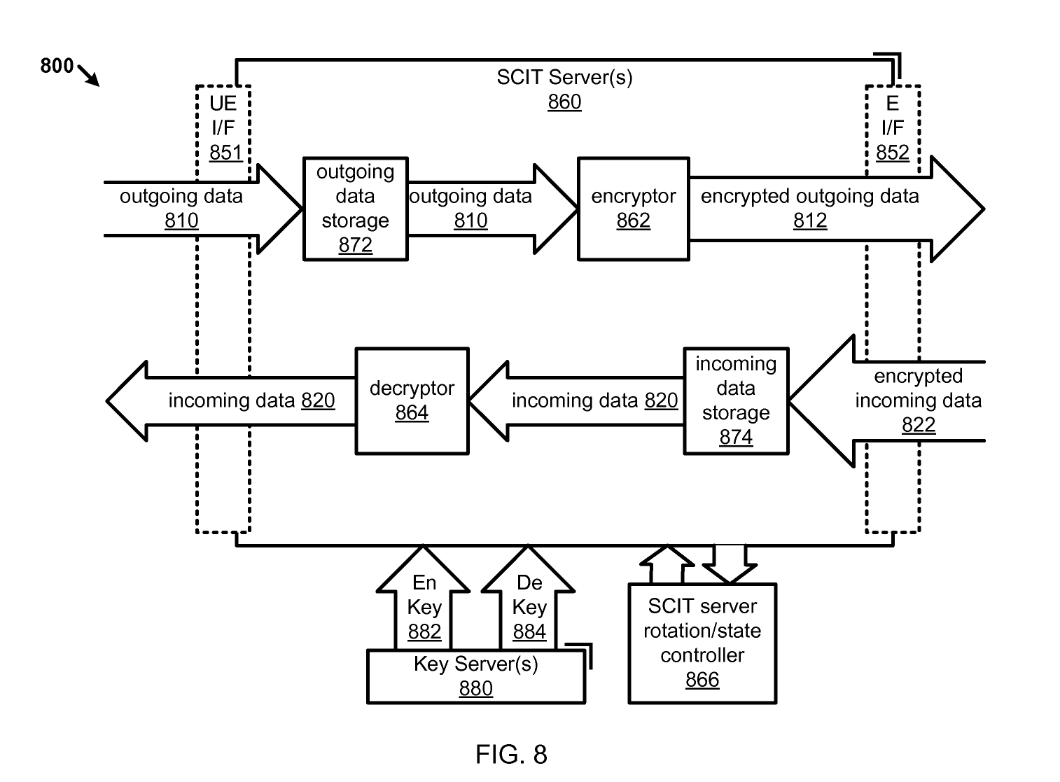

FIG. 8 illustrates an embodiment of a secure gateway 800 comprising separate outgoing data storage 872 and incoming data storage 874 located internal to SCIT server(s) 860. In this illustrative embodiment, outgoing data 810 from an internal network may be received by the SCIT server(s) 860 through unexposed interface 851 and stored in outgoing data storage 872 during an unexposed mode. The outgoing data 810 may be encrypted by encryptor 862 employing an encryption key 882 obtained from key server(s) 880. During an exposed mode, the SCIT server(s) 860 may transport the encrypted outgoing data 812 to an external network via exposed interface 852. Encrypted incoming data 822 may be received by SCIT server(s) 860 via exposed interface 852 during an exposed mode. Encrypted incoming data 822 may be stored in incoming data storage 874. Decryptor 864 may generate incoming data 820 by decrypting the encrypted incoming data 822 employing a decryption key 884 obtained from key server(s) 880. During an unexposed mode, incoming data 820 may be may be transported by the SCIT server(s) 860 through unexposed interface 851 to the internal network. The mode of the SCIT server(s) 860 may be controlled via a SCIT server rotation/mode controller 866. Although the SCIT server rotation/mode controller 866 is illustrated external to the SCIT server(s) 860, according to some of the various embodiments, the SCIT server rotation/mode controller 866 functionality may be performed internal and/or in between the SCIT server(s) 860.

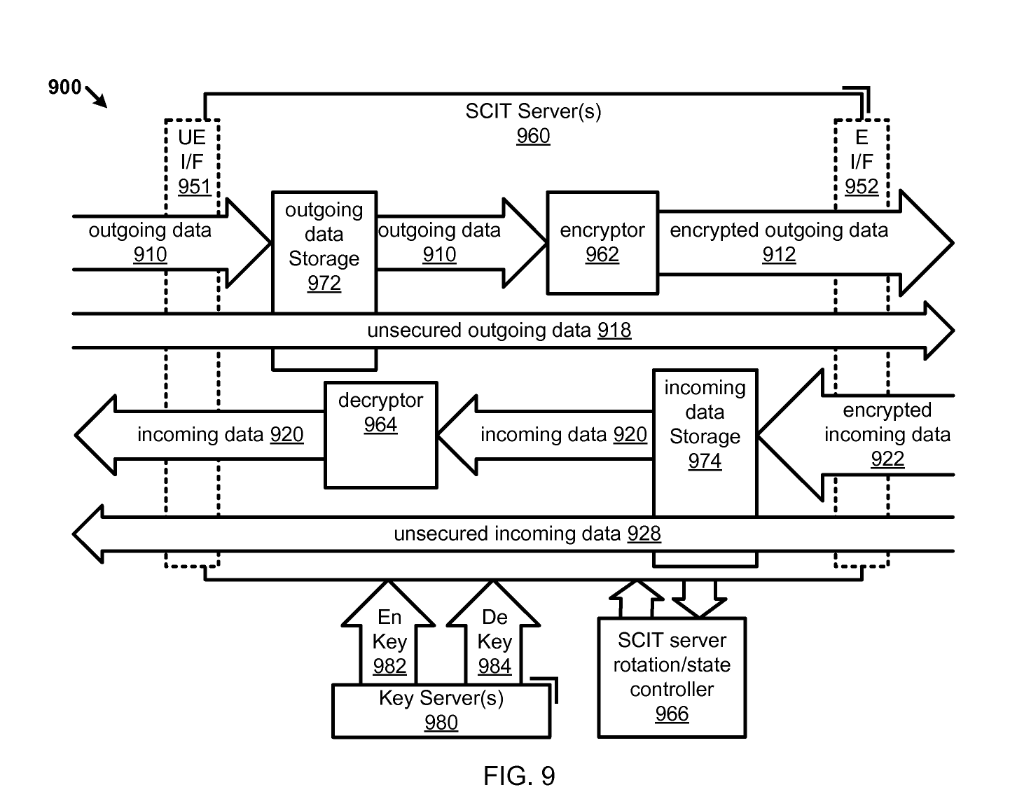

FIG. 9 illustrates an embodiment of a secure gateway 900 comprising an additional pathway for unsecured outgoing data 918 and/or unsecured incoming data 928. This example is illustrated to show that options may be implemented to allow certain data to be passed between the internal and external networks unsecured. In these cases, outgoing data may be categorized as needing security and not needing security. For example, outgoing data 910 may be data that is determined to be secured, whereas unsecured outgoing data 918 may be determined as data that does not need to be secured. Similarly, encrypted incoming data 922 may be data that is determined to be secured, whereas unsecured incoming data 928 may be determined as data that does not need to be secured. Examples of data that does not need to be secured may be personal data moving through the internal network (as opposed to business data moving through the internal network).

In this illustrative embodiment, secured data may be processed as described in earlier embodiments. For example, outgoing data 910 from an internal network may be received by the SCIT server(s) 960 through unexposed interface 951 and stored in outgoing data storage 972 during an unexposed mode. The outgoing data 910 may be encrypted by encryptor 962 employing an encryption key 982 obtained from key server(s) 980. During an exposed mode, the SCIT server(s) 960 may transport the encrypted outgoing data 912 to an external network via exposed interface 952. Encrypted incoming data 922 may be received by SCIT server(s) 960 via exposed interface 952 during an exposed mode. Encrypted incoming data 922 may be stored in incoming data storage 974. Decryptor 964 may generate incoming data 920 by decrypting the encrypted incoming data 922 employing a decryption key 984 obtained from key server(s) 980. During an unexposed mode, incoming data 920 may be may be transported by the SCIT server(s) 960 through unexposed interface 951 to the internal network. The mode of the SCIT server(s) 960 may be controlled via a SCIT server rotation/mode controller 966. Although the SCIT server rotation/mode controller 966 is illustrated external to the SCIT server(s) 960, according to some of the various embodiments, the SCIT server rotation/mode controller 966 functionality may be performed internal and/or in between the SCIT server(s) 960.

In this illustrative embodiment, unsecured data may be processed in various fashions. For example, unsecured outgoing data 918 from an internal network may be received by the SCIT server(s) 960 through unexposed interface 951 and stored in outgoing data storage 972 during an unexposed mode. The unsecured outgoing data 918 may be transported to an external network via exposed interface 952 during an exposed mode. Alternatively, some embodiments may enable unsecured outgoing data 918 to merely pass through the SCIT server(s) 960 without being stored in outgoing data storage 972. Unsecured incoming data 928 may be received by SCIT server(s) 960 via exposed interface 952 during an exposed mode and stored in incoming data storage 974. During an unexposed mode, unsecured incoming data 928 may be transported by the SCIT server(s) 960 through unexposed interface 951 to the internal network. In alternative embodiments, unsecured incoming data 928 may be allowed to merely pass through the SCIT server(s) 960 without being stored in the incoming data storage 974. In yet other embodiments, the unsecured outgoing data 918 and/or unsecured incoming data 928 may pass through SCIT server(s) 960 via interfaces separate from unexposed interface 951 and exposed interface 952.

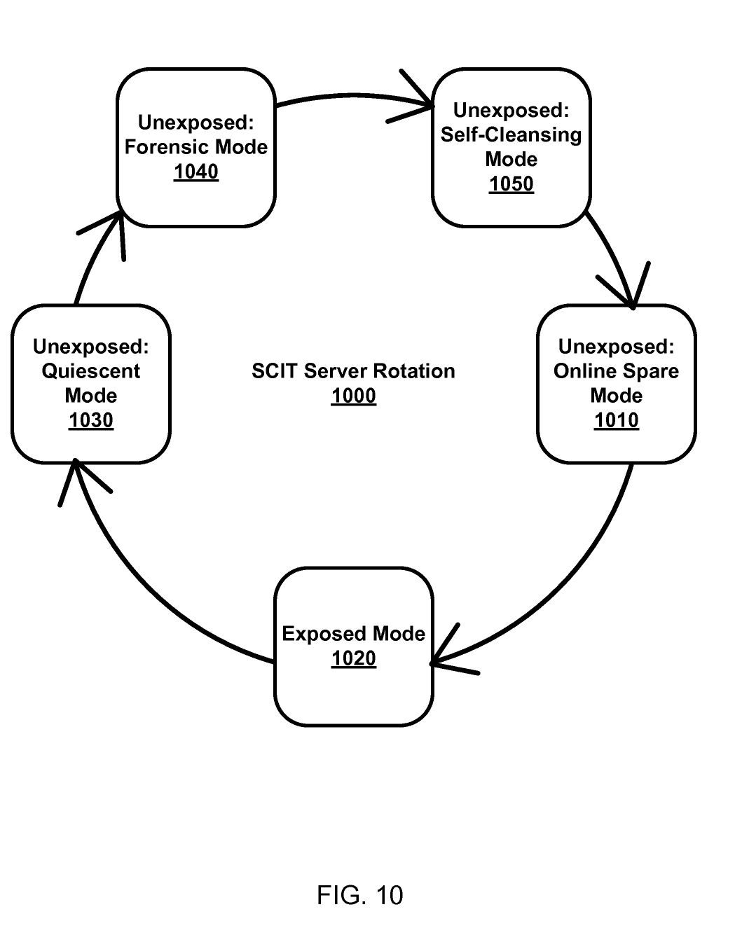

FIG. 10 is an example diagram illustrating example SCIT server rotations 1000 as per various aspects of embodiments of the present invention. As described earlier, SCIT server(s) may rotate through a series of exposed and unexposed modes. During an exposed mode 1020, the SCIT server may enable communication interfaces to external networks, thereby exposing the server to potential outside threats. To counter these threats, the SCIT server(s) may rotate into a series of unexposed modes wherein the communication interfaces to external networks are disabled, effectively isolating the SCIT server from the external network. In some of the various embodiments, some unexposed modes may isolate the gateway from both internal and external networks. Various embodiments of the SCIT servers may incorporate different exposed and unexposed modes. FIG. 10 illustrated four example unexposed modes: a quiescent mode 1030, a forensic mode 1040, a self-cleansing mode 1050, and an online spare mode 1010. Those skilled in the art will recognize that other modes may be practiced so long as during unexposed modes, the external network is isolated from the SCIT server.

In a quiescent mode, data collection and processing may continue to operate, but, communications with the external network is ceased. In this way, communications may continue with an internal network as well as processing of data destined for and/or from the external network can proceed. According to some of the various embodiments, this mode may be employed to complete the pending actions and processes.

In a forensic mode 1040, steps may be taken to determine how a SCIT server was used and whether the SCIT server was compromised. Log files may be examined. For example, intrusion alert system logs and usage logs may be examined. Disk accesses and network connections may be analyzed. URL access data may be analyzed. Additionally, the state of the system may be analyzed. A check may be made to see if the system was patched or otherwise modified. For example, a check may be made for the presence of abnormal network connections, rootkits, strange directories, and binary files recently installed. This data may be saved and/or reported.

In a self-cleansing mode 1050, the SCIT server may be reset to a known good state. In some cases, this may involve shutting down a virtual server completely and restarting a new pristine virtual server as a replacement. In other cases, the server may be rebooted. In yet other cases, a server may be reloaded with new operating instructions and a clean memory image. The rotations into the self-cleansing mode may be based on time (e.g. every x seconds), or processing based (e.g. every X data processing cycle(s)). More frequent the rotations should decrease the SCIT server exposure time. Less frequent rotations may allow longer processes to complete.

Once a SCIT server has be cleaned in the self-cleansing mode 1050, the SCIT server may move into an online spare mode 1010. In an online spare mode 1010, the server may be added to a server queue until needed. Need may be affected by variables such as the number of total servers, network traffic, time of day, and/or the like.

Some of the various embodiments may employ clusters of SCIT servers. Some of the outgoing data may be organized as multiple files. The clusters of SCIT servers may reside on virtual machines. The virtual machines may reside on one or more physical computing machines. The SCIT controller may coordinate rotations of the SCIT servers and may enforce rules about the number of SCIT servers that may be exposed to an external network at any time. In these cases, some embodiments may be configured with multiple SCIT servers. While one SCIT server processes one of the multiple files, another SCIT server may processes another of the multiple files.

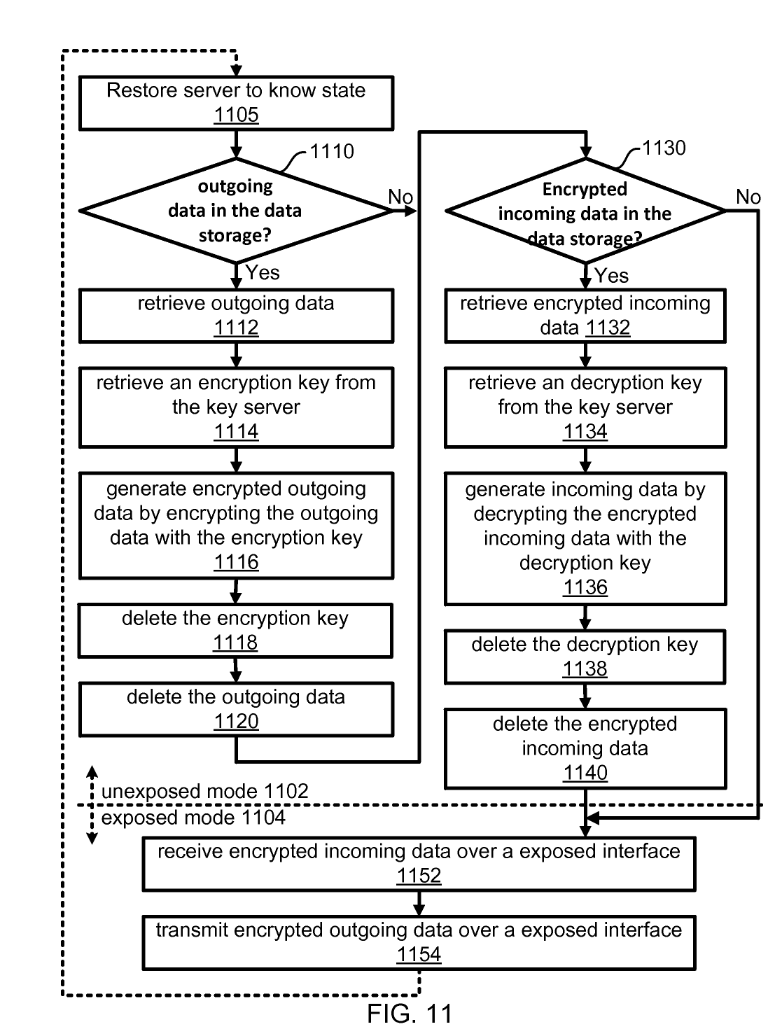

FIG. 11 is an example flow diagram of a secure gateway operation(s) as per aspects of an embodiment of the present invention. This illustrative example splits the flow between flows that may occur during unexposed mode(s) 1102 and flows that may occur during exposed mode(s) 1004. However, one skilled in the art will recognize that the flow illustrated in this diagram is only an example and that other flows may occur as per other embodiments where some of the flow designated as unexposed 1002 may occur during exposed modes 1004 and vice versa.

During the unexposed mode(s) 1102, the server may be restored to a known state at 1105. At 1110, a determination may be made if there is outgoing data in data storage. If the determination is positive, then the server may rotate through a series of actions to process the outgoing data. At 1112, outgoing data may be retrieved from the data storage. An encryption key may be retrieved from a key server at 1114. Encrypted outgoing data may be generated by encrypting the outgoing data with the encryption key at 1116. At 1118, the encryption key may be deleted. The outgoing data may be deleted at 1120. In some embodiments, the outgoing data may be deleted from the data storage.

At 1130, a determination may be made if there is encrypted incoming data in data storage. If the determination is positive, then the server may rotate through a series of actions to process the encrypted incoming data. At 1132, encrypted incoming data may be retrieved from the data storage. A decryption key may be retrieved from the key server at 1134. At 1136, incoming data may be generated by decrypting the encrypted incoming data with the decryption key. The decryption key may be deleted at 1138. At 1140, the encrypted incoming data may be deleted. The encrypted incoming data may be deleted from the data storage.

In the exposed mode(s) 1104, encrypted incoming data may be received over the exposed interface at 1152 and encrypted outgoing data may be transmit over the exposed interface at 1154.

Other actions may also be performed through the various mode(s). For example, outgoing data may be received over the unexposed interface and incoming data may be transmitted over the unexposed interface. The unexposed interface may be employed to communicate with an application program running on a computing machine. Encrypted outgoing data and/or incoming data may be stored on the data storage. The data storage may reside in a persistent storage device.

At least some of the outgoing data may be organized as multiple files. In these cases, a first SCIT server may process at least one of the multiple files while at least one additional SCIT server processes at least another of the multiple files.

The exposed mode(s) may also be configured to store the encrypted incoming data in the data storage and to retrieve the encrypted outgoing data from the data storage. The unexposed mode may rotate though at least one of the following: an online spare mode; a quiescent mode; a self-cleansing mode; and a forensics mode. The rotations may occur at time intervals and/or at data processing intervals. In yet other embodiments, rotations may be driven by event(s) and/or an external source. The unexposed mode may further store the incoming data in the data storage, and/or store the encrypted outgoing data in the data storage. During the unexposed mode, the one or more processors may be isolated from internal and external networks.

The SCIT server(s) may also be configured to receive unsecured outgoing data over unsecured interface and/or to transmit unsecured outgoing data over the exposed interface, and/or receive unsecured incoming data over the exposed interface and/or transmit unsecured incoming data over the unexposed interface.

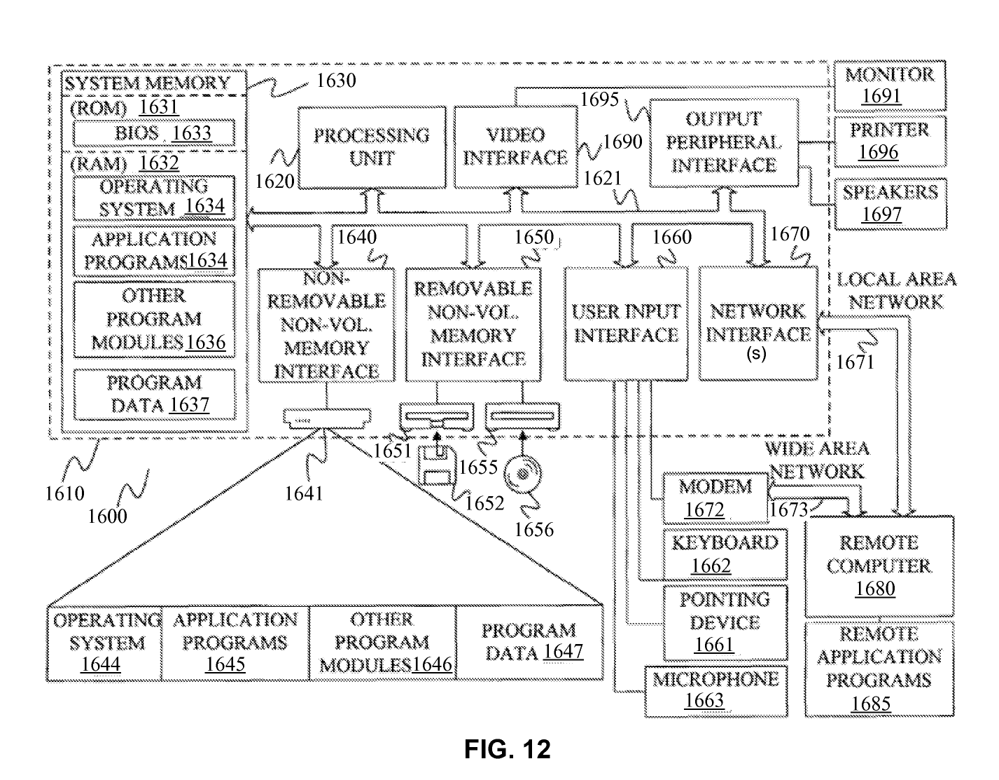

FIG. 12 illustrates an example of a suitable computing system environment 1600 on which embodiments may be implemented. The computing system environment 1600 is only one example of a suitable computing environment and is not intended to suggest any limitation as to the scope of use or functionality of the claimed subject matter. Neither should the computing environment 1600 be interpreted as having any dependency or requirement relating to any one or combination of components illustrated in the exemplary operating environment 1600.

Embodiments are operational with numerous other general purpose or special purpose computing system environments or configurations. Examples of well-known computing systems, environments, and/or configurations that may be suitable for use with various embodiments include, but are not limited to, servers, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices.

With reference to FIG. 12, an example system for implementing some embodiments includes a general-purpose computing device in the form of a computer 1610. The computer 1610 may be a server or a server compatible device. Components of computer 1610 may include, but are not limited to, a processing unit 1620, a system memory 1630, and a system bus 1621 that couples various system components including the system memory to the processing unit 1620.

Computer 1610 typically includes a variety of computer readable media. Computer readable media can be any available media that can be accessed by computer 1610 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 1610. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 1630 includes computer storage media in the form of volatile and/or nonvolatile memory such as read only memory (ROM) 1631 and random access memory (RAM) 1632. A basic input/output system 1633 (BIOS), containing the basic routines that help to transfer information between elements within computer 1610, such as during start-up, is typically stored in ROM 1631. RAM 1632 typically contains data and/or program modules that are immediately accessible to and/or presently being operated on by processing unit 1620. By way of example, and not limitation, FIG. 12 illustrates operating system 1634, application programs 1635, other program modules 1636, and program data 1637.

The computer 1610 may also include other removable/non-removable volatile/nonvolatile computer storage media. By way of example only, FIG. 12 illustrates a hard disk drive 1641 that reads from or writes to non-removable, nonvolatile magnetic media, a magnetic disk drive 1651 that reads from or writes to a removable, nonvolatile magnetic disk 1652, and an optical disk drive 1655 that reads from or writes to a removable, nonvolatile optical disk 1656 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 1641 is typically connected to the system bus 1621 through a non-removable memory interface such as interface 1640, and magnetic disk drive 1651 and optical disk drive 1655 are typically connected to the system bus 1621 by a removable memory interface, such as interface 1650.

The drives and their associated computer storage media discussed above and illustrated in FIG. 12, provide storage of computer readable instructions, data structures, program modules and other data for the computer 1610. In FIG. 12, for example, hard disk drive 1641 is illustrated as storing operating system 1644, position-dependent phonetic language model 212 and decoder 312.

A user may enter commands and information into the computer 1610 through input devices such as a keyboard 1662, a microphone 1663, and a pointing device 1661, such as a mouse, trackball or touch pad. These and other input devices are often connected to the processing unit 1620 through a user input interface 1660 that is coupled to the system bus, but may be connected by other interface and bus structures, such as a parallel port, game port or a universal serial bus (USB). A monitor 1691 or other type of display device is also connected to the system bus 1621 via an interface, such as a video interface 1690.

The computer 1610 is operated in a networked environment using logical connections to one or more remote computers, such as a remote computer 1680. The remote computer 1680 may be a personal computer, a hand-held device, a server, a router, a network PC, a peer device or other common network node, and typically includes many or all of the elements described above relative to the computer 1610. The logical connections depicted in FIG. 12 include a local area network (LAN) 1671 and a wide area network (WAN) 1673, but may also include other networks. Such networking environments are commonplace in offices, enterprise-wide computer networks, intranets and the Internet.

When used in a LAN networking environment, the computer 1610 is connected to the LAN 1671 through a network interface or adapter 1670. When used in a WAN networking environment, the computer 1610 typically includes a modem 1672 or other means for establishing communications over the WAN 1673, such as the Internet. The modem 1672, which may be internal or external, may be connected to the system bus 1621 via the user input interface 1660, or other appropriate mechanism. In a networked environment, program modules depicted relative to the computer 1610, or portions thereof, may be stored in the remote memory storage device. By way of example, and not limitation, FIG. 12 illustrates remote application programs 1685 as residing on remote computer 1680. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

In this specification, “a” and “an” and similar phrases are to be interpreted as “at least one” and “one or more.” References to “an” embodiment in this disclosure are not necessarily to the same embodiment.

Many of the elements described in the disclosed embodiments may be implemented as modules. A module is defined here as an isolatable element that performs a defined function and has a defined interface to other elements. The modules described in this disclosure may be implemented in hardware, a combination of hardware and software, firmware, or a combination thereof, all of which are behaviorally equivalent. For example, modules may be implemented using computer hardware in combination with software routine(s) written in a computer language (such as C, C++, Fortran, Java, Basic, Matlab or the like) or a modeling/simulation program such as Simulink, Stateflow, GNU Octave, or LabVIEW MathScript. Additionally, it may be possible to implement modules using physical hardware that incorporates discrete or programmable analog, digital and/or quantum hardware. Examples of programmable hardware include: computers, microcontrollers, microprocessors, application-specific integrated circuits (ASICs); field programmable gate arrays (FPGAs); and complex programmable logic devices (CPLDs). Computers, microcontrollers and microprocessors are programmed using languages such as assembly, C, C++ or the like. FPGAs, ASICs and CPLDs are often programmed using hardware description languages (HDL) such as VHSIC hardware description language (VHDL) or Verilog that configure connections between internal hardware modules with lesser functionality on a programmable device. Finally, it needs to be emphasized that the above mentioned technologies may be used in combination to achieve the result of a functional module.

While various embodiments have been described above, it should be understood that they have been presented by way of example, and not limitation. It will be apparent to persons skilled in the relevant art(s) that various changes in form and detail can be made therein without departing from the spirit and scope. In fact, after reading the above description, it will be apparent to one skilled in the relevant art(s) how to implement alternative embodiments. Thus, the present embodiments should not be limited by any of the above described exemplary embodiments. In particular, it should be noted that, for example purposes, the above explanation has focused on the example(s) servers. However, one skilled in the art will recognize that embodiments of the invention could be employed to provide a gateway between other types of systems, such as multimedia streaming, telephony, social networks, and/or the like.

In addition, it should be understood that any figures that highlight any functionality and/or advantages, are presented for example purposes only. The disclosed architecture is sufficiently flexible and configurable, such that it may be utilized in ways other than that shown. For example, the steps listed in any flowchart may be re-ordered or only optionally used in some embodiments.

Further, the purpose of the Abstract of the Disclosure is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract of the Disclosure is not intended to be limiting as to the scope in any way.

Finally, it is the applicant's intent that only claims that include the express language “means for” or “step for” be interpreted under 35 U.S.C. 112, paragraph 6. Claims that do not expressly include the phrase “means for” or “step for” are not to be interpreted under 35 U.S.C. 112, paragraph 6.

What is claimed is:

1. A secure gateway comprising:
a) data storage configured to hold:
i) outgoing data; and
ii) encrypted incoming data; and
b) a server configured to rotate through:
i) an unexposed mode configured to:
(1) restore the server to a known state;
(2) if there is outgoing data in the data storage:
(a) retrieve outgoing data from the data storage;
(b) retrieve an encryption key from a key server;
(c) generate encrypted outgoing data by encrypting the outgoing data with the encryption key;
(d) delete the encryption key; and
(e) delete the outgoing data from the data storage; and
(3) if there is encrypted incoming data in the data storage:
(a) retrieve encrypted incoming data from the data storage;
(b) retrieve a decryption key from the key server;
(c) generate incoming data by decrypting the encrypted incoming data with the decryption key;
(d) delete the decryption key; and
(e) delete the encrypted incoming data; and
ii) an exposed mode configured to:
(1) receive encrypted incoming data over a exposed interface; and
(2) transmit encrypted outgoing data over a exposed interface.

2. The secure gateway according to claim 1, wherein the unexposed interface is further configured to:
a) receive outgoing data; and
b) transmit incoming data.

3. The secure gateway according to claim 1, wherein the unexposed interface communicates with a computing system running an application program.

4. The secure gateway according to claim 1, wherein the data storage is further configured to hold:
a) encrypted outgoing data; and
b) incoming data.

5. The secure gateway according to claim 1, wherein the data storage resides in a persistent storage device.

6. The secure gateway according to claim 1, wherein the exposed mode if further configured to:
a) store the encrypted incoming data in the data storage; and
b) retrieve the encrypted outgoing data from the data storage.

7. The secure gateway according to claim 1, wherein the encryption key and the decryption key are the same symmetric key.

8. The secure gateway according to claim 1, wherein:
a) at least some of the outgoing data is organized as multiple files;
b) the first server processes at least one of the multiple files; and
c) at least one of the at least one additional server processes at least another of the multiple files.

9. The secure gateway according to claim 1, wherein at least one of the first server and at least one additional server resides on at least one virtual machine, the at least one virtual machine residing on a computing system.

10. The secure gateway according to claim 1, wherein at least one of the first server and at least one additional server resides on separate physical computing systems.

11. The secure gateway according to claim 1, further including a server state controller configured to control the mode rotation of the:
a) the first server; and
b) at least one additional server.

12. The secure gateway according to claim 11, wherein the server state controller is further configured to ensure that only one of the first server and the at least one additional server is in an exposed mode at one time.

13. The secure gateway according to claim 1, wherein the unexposed mode is further configured to rotate through at least one of the following:
a) an online spare mode;
b) a quiescent mode;
c) a self-cleansing mode; and
d) a forensics mode.

14. The secure gateway according to claim 1, wherein the first sever is further configured to rotate at time intervals.

15. The secure gateway according to claim 1, wherein the first server is further configured to rotate at data processing intervals.

16. The secure gateway according to claim 1, wherein the unexposed mode if further configured to:
a) store the incoming data in the data storage; and
b) store the encrypted outgoing data in the data storage.

17. The secure gateway according to claim 1, wherein during the unexposed mode, the gateway is isolated from internal and external networks.

18. The secure gateway according to claim 1, wherein the unexposed mode further configured to boot the first server into a known good server state.

19. The secure gateway according to claim 1, wherein the exposed interface is further configured to:
a) transmit unsecured outgoing data; and
b) receive unsecured incoming data.

20. The secure gateway according to claim 1, wherein the unexposed interface is further configured to:
a) receive unsecured outgoing data; and
b) transmit unsecured incoming data.
